(19) United States
(12) Patent Application Publication
(10) Pub. No.: US 2005/0117748 A1
(43) Pub. Date: Jun. 2, 2005

(54) Secure visual message communication method and device

(75) Inventors: Geert Jan Schrijen, Eindhoven (NL); Pim Theo Tuyls, Eindhoven (NL); Thomas Andreas Maria Kevenaar, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N. V., Eindhoven (NL)

(21) Appl. No.: 10/503,684

(22) PCT Filed: Jan. 27, 2003
(86) PCT No.: PCT/IB03/00261

(30) Foreign Application Priority Data
Feb. 7, 2002 (EP) 02075527.8

(51) Int. Cl. H04N 7/167

(52) U.S. Cl. 380/200

(57) ABSTRACT

A method of and a device (501) for reconstructing a graphical message (520) using visual cryptography. Cells (303, 304) in a first liquid crystal display (701) are activated if a bit in a message sequence represents ‘1’, and not activated if said bit represents ‘0’. Cells (303, 304) in a second liquid crystal display (511) are activated if a bit in a key sequence represents ‘0’, and not activated if said bit represents ‘1’. The first and second displays (701, 511) are then superimposed so as to visually reconstruct the graphical message (520). Preferably a portion of a polarization filter (305) in an area of the first liquid crystal display (701), and a corresponding portion of a polarization filter (302) in an area of the second liquid crystal display (511) have been omitted to allow superimposition of the first and second liquid crystal displays (701, 511) at said areas.

The invention relates to a method of reconstructing a graphical message, and to a device arranged for reconstructing a graphical message.

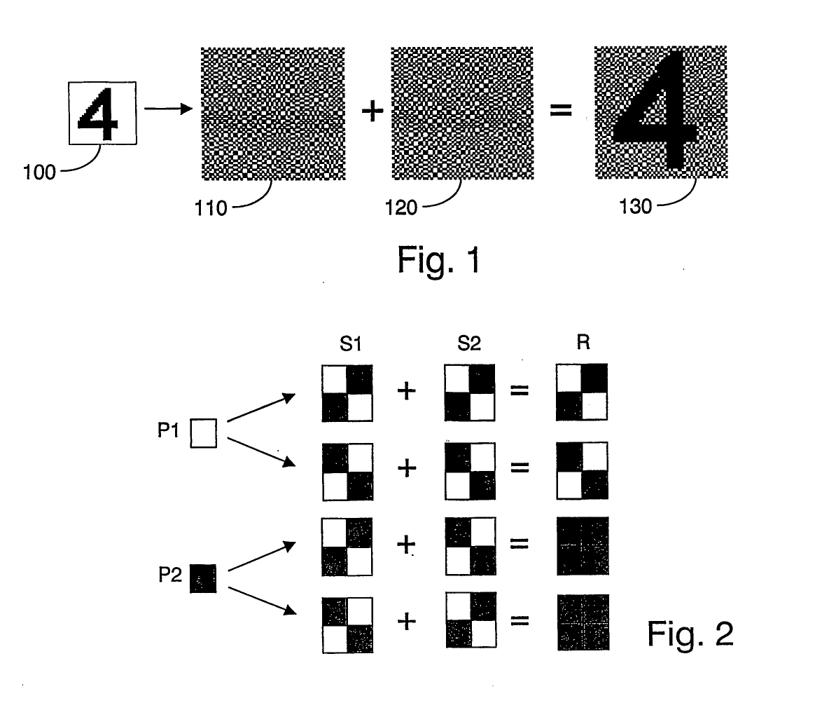

Visual cryptography (M. Naor, A. Shamir: Visual Cryptology, Eurocrypt '94, Springer-Verlag LNCS Vol. 950, Springer-Verlag, 1995, pp 1-12) can briefly be described as follows. An image is split into two randomized parts, the image plus a randomization and the randomization itself. Either part contains no information on the original image because of the randomization. However, when both parts are physically overlaid the original image is reconstructed. An example is given in FIG. 1: original image 100 is split into shares 110 and 120, which when overlaid result in reconstructed image 130.

If the two parts do not fit together, no information on the original image is revealed and a random image is produced. Therefore if two parties want to communicate using visual cryptography, they have to share the randomization. A basic implementation would be to give a receiving party a transparency containing the randomization. The sender would then use this randomization to randomize the original message, and transmits the randomized message to the receiver, on a transparency or by any other means. The receiver puts the two transparencies on top of each other and recovers the message. This scheme can be compared to a one-time pad.

A more flexible implementation is obtained when using two display screens, e.g. two LCD screens. A first screen displays the image plus randomization and a second screen displays the randomization itself. If the screens are put on top of each other, the reconstructed image appears.

FIG. 2 illustrates the visual cryptography process as devised by Naor and Shamir in the above-referenced paper. The process is illustrated here for a single pixel, but of course every pixel in the source image is to be processed in this way.

Every pixel of the original image 100 is translated to four sub-pixels. To generate the first share S1 for this pixel, two of the four pixels are randomly chosen to be black (non-transparent) while the other two are chosen to be white (transparent). To generate the other share S2 of this pixel the four sub-pixels are copied if the corresponding pixel in the original image was white and they are inverted if the original pixel was black. For each pixel a new random choice of which two of the four pixels should be black (non-transparent) needs to be made. The number of sub-pixels into which the pixels are split can be chosen arbitrarily, but should be at least two.

This way, two collections of sub-pixels are formed. These collections make up the two shares. Neither of the shares gives any information on the color of the original pixel. In all cases, some of the sub-pixels chosen to represent the original pixel in either of the shares are black and the rest is white. Further, all possible combinations of black and white are equally likely to occur, since the random choice is made with a probability of p=0.5, independently for each pixel.

To reconstruct the original image, the two shares S1 and S2 are to be superimposed, i.e. put on top of each other. This is shown in the last column (R) of FIG. 2. If the original pixel were black (P2), then the superposition of the sub-pixels from shares S1 and S2 will result in four black sub-pixels. If the original pixel where white (P1) , then the superposition of the sub-pixels from shares S1 and S2 will result in a black and white pattern in the reconstructed image 130, which often appears to be gray when seen from a distance.

If the two parts do not fit together no information on the original image is revealed and a random image is produced. Without knowing both of the shares, the probability that one set of sub-pixels corresponds to a white pixel in the original image 100 is equal to the probability that set corresponds to a black pixel in the original image 100.

It is clear that the above scheme suffers from several disadvantages. First, in order to show the same level of detail in the reconstructed image 130, the shares 110, 120 require a four times higher resolution than the original image 100. This makes the reconstructed image 130 four times as large as the original image 100.

Further, the contrast and brightness of the reconstructed image 130 is severely reduced compared to the contrast and brightness of the original image 100. This is due to the fact that white pixels in the original image 100 turn into a pattern of black and white pixels in the reconstructed image 130. This also causes a small distortion at the edges of the parts that were black in the original image 100. These effects can be seen clearly in FIG. 1.

Thus, while substituting LCD screens for transparencies in a visual cryptography system does introduce additional flexibility with respect to messages and keys, the visual cryptography system needs to be improved to overcome the above-mentioned disadvantages.

It is an object of the invention to provide a method according to the preamble, in which the quality of the reconstructed image is improved.

This object is achieved according to the invention in a method comprising receiving a sequence of information units, activating cells in a first liquid crystal layer of a first liquid crystal display in dependence on the sequence, activating cells in a second liquid crystal layer of a second liquid crystal display, different from the first liquid crystal display, in dependence on elements in a key sequence, and superimposing the first and second displays so as to reconstruct the graphical message.

After receiving the sequence of information units, preferably a sequence of binary values, the sequence is rendered on the first liquid crystal display by activating or not activating cells in the liquid crystal layer. Observe that no processing or decrypting step is necessary before any displaying takes place; the information units are displayed as they are received. On a second display another pattern is displayed, which is generated based entirely on a key sequence.

Reconstruction of the image is performed by superimposing the first and second displays in the correct alignment, so that the user can see the reconstructed graphical message. The reconstruction is performed directly by the human eye and not by a device which might be compromised. This makes the use of visual cryptography to communicate secret information more secure.

In an embodiment polarized light is incident on the liquid crystal layers. This light could originate from a polarized light source, or from an ordinary light source and then passing through a first polarization filter. The polarized light then passes through the first and second liquid crystal layers, and finally through a second polarization filter.

The polarization filters only let light through with a particular polarization. Normally a liquid crystal cell rotates the polarization of the light that passes through it over a certain angle. If a sufficient voltage is applied to the cell, no rotation takes place. This is referred to as “activating” that cell. Light will not be visible if the total rotation of the polarization of the incoming light by the two liquid crystal layers is perpendicular to the polarization direction of the second polarization filter.

In prior art visual cryptography systems, as explained above, every pixel in a source graphic was mapped to two or more pixels in the reconstructed graphic. Also, white pixels were mapped to black-and-white patterns, reducing the sharpness of the reconstructed image. This makes messages in such images harder to read. However, according to the invention only one cell, and hence one output pixel, is necessary for every input pixel. This maintains the sharpness and clarity of the original image in the reconstruction.

In an embodiment the method comprises for each information unit in the sequence, activating a corresponding cell in the first liquid crystal layer if the information unit represents a first value, and not activating the corresponding cell if the information unit represents a second value. Preferably the first value is the binary value ‘1’ and the second value is the binary value ‘0’. This way a direct one-to-one mapping of information units to activated and not activated cells is obtained.

In a further embodiment the method comprises for each element in the key sequence, activating a corresponding cell in the second liquid crystal layer if the element represents a second value, and not activating the corresponding cell if the element represents a first value. In this way a direct one-to-one mapping of key sequence elements to activated and not activated cells is obtained.

It is an object of the invention to provide a device according to the preamble, in which the quality of the reconstructed image is improved.

This object is achieved according to the invention in a device comprising receiving means for receiving a sequence of information units, a first liquid crystal display arranged for displaying the sequence of information units by activating cells in a first liquid crystal layer in dependence on the sequence, a second liquid crystal display, different from the first liquid crystal display, arranged for activating cells in a second liquid crystal layer in dependence on elements in a key sequence, in which the first and second liquid crystal displays are arranged to be superimposed on each other.

In an embodiment the second liquid crystal display is embodied in a unit physically separable from the first display, and provided with a memory for storing the key sequence. No electrical, optical or other communication paths between the first and second displays, or the devices in which they are embodied, should exist. As the patterns and the key sequence are provided in digital (electronic) form, any such communication paths could potentially be abused by an attacker to obtain patterns and/or key sequence.

In this way, it is achieved that the user does not have to trust the security of the client device comprising the first liquid crystal display, but only this separate unit, comprising the second liquid crystal display. The user now does not have to worry that the client device, which could be e.g. an automated teller machine or public Internet terminal or the like, is compromised by an attacker so as to capture information sent to him. Even if the client device were captured, the attacker cannot recover the original message, because he cannot gain access to the information in the separate unit.

In a further embodiment the device comprises means for receiving input representing a set of coordinates from a user, and means for transmitting the received input to a server. One particularly advantageous way to use the present invention is to securely transmit a graphical message representing plural input means, such as buttons or keys on a keyboard, to the device. Having reconstructed the message, a user can then compose a message of his own, e.g. his password or PIN, by selecting keys or other input means rendered as an image on the display of the client device.

As the input means are only visible to the user, the device cannot register which input means have been selected by the user. However, it can register sets of coordinates from e.g. mouseclicks made by the user. The server that sent the graphical message can translate the sets of coordinates back to the input means selected by the user, and can so recover the message entered by the user in this fashion.

In a variant of this embodiment the input is received as pressure on a particular spot of the fist liquid crystal display, the set of coordinates corresponding to the particular spot. Using a touch-screen is a very easy way of selecting input means on a display. Further, it is not necessary to display a cursor or other indication on the first or second display, which cursor might interfere with the display of the patterns.

In a further embodiment the device further comprises at least one polarizing means for polarizing light incident upon the first and second liquid crystal layers.

In a further embodiment a portion of a polarization filter in an area of the first liquid crystal display, and a corresponding portion of a polarization filter in an area of the second liquid crystal display have been omitted to allow superimposition of the first and second liquid crystal displays at said areas. This makes it very easy for a user to superimpose the second liquid crystal display on the first, as it is immediately clear where to put the second liquid crystal display. It also makes it possible to display other information, such as instructions, in other areas of the first liquid crystal display, so that the user can e.g. be informed that he must superimpose the second liquid crystal display on the first.

In a further embodiment the second liquid crystal layer is operable to be inserted between a polarization filter of the first liquid crystal display and the first liquid crystal layer in the first liquid crystal display. This has the advantage that the first liquid crystal display now is fully operable as a conventional liquid crystal display when the second liquid crystal display is not inserted.

These and other aspects of the invention will be apparent from and elucidated with reference to the embodiments shown in the drawings, in which:

FIG. 1 shows an original image, two shares obtained by visually encrypting the original image and a reconstructed image obtained by superimposing the two shares;

FIG. 2 illustrates the visual cryptography process as devised by Naor and Shamir in the above-referenced paper,

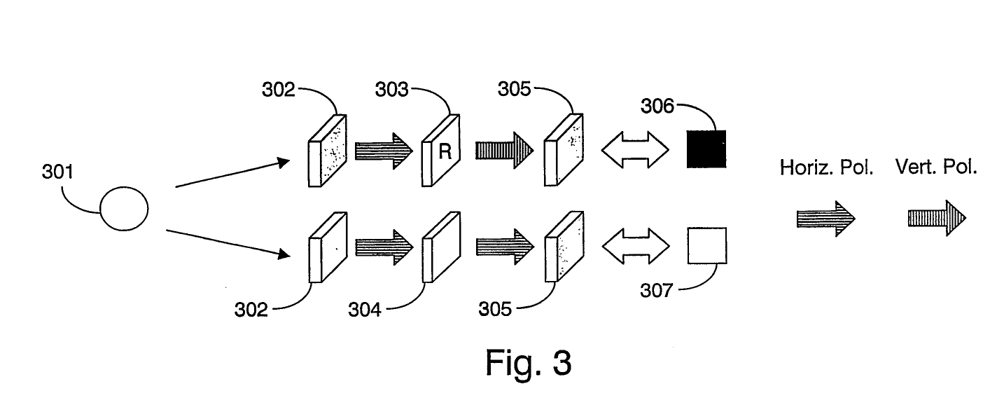

FIG. 3 schematically shows the construction of a liquid crystal display;

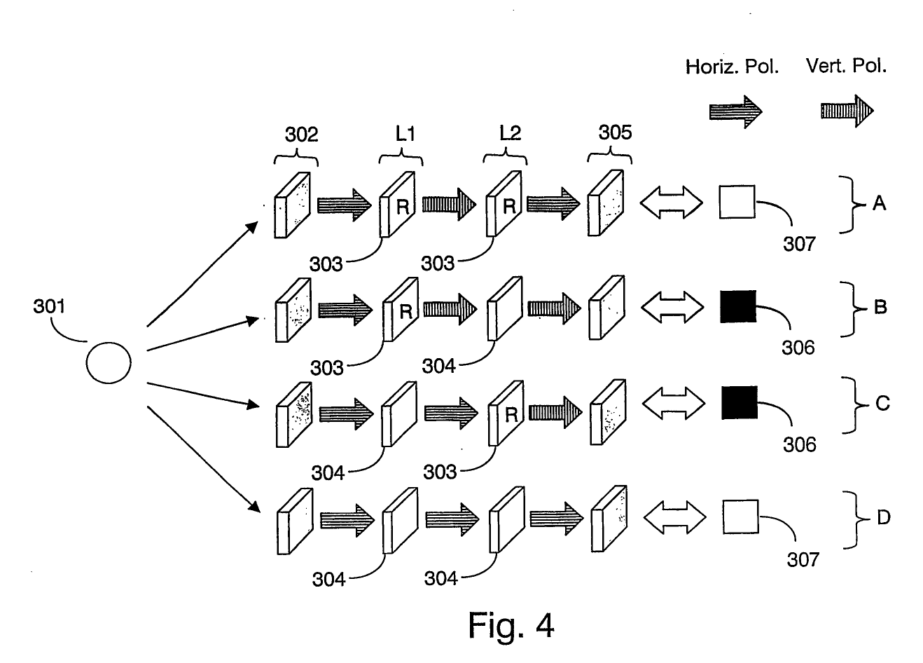

FIG. 4 schematically shows a modified liquid crystal display with two liquid crystal layers;

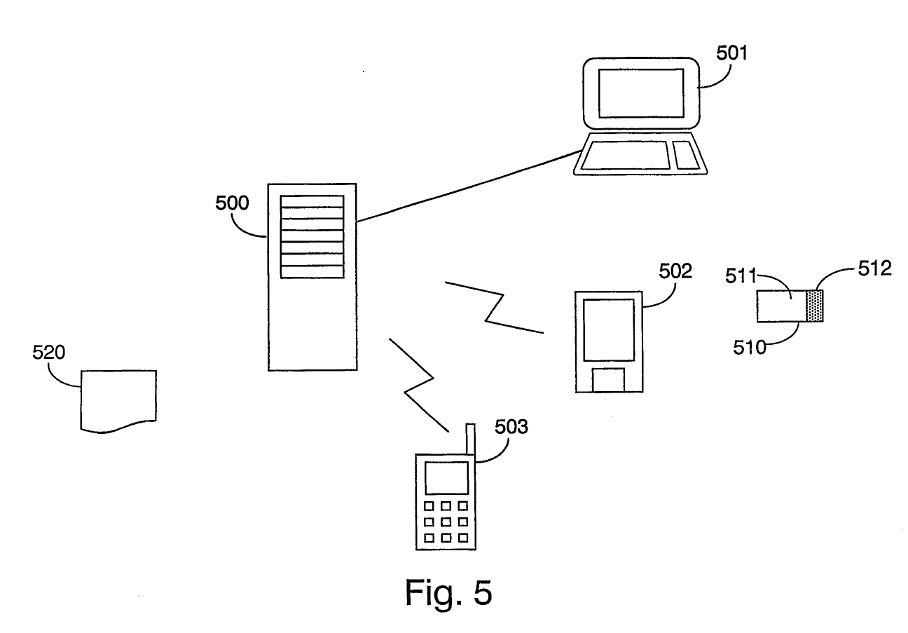

FIG. 5 schematically shows a system comprising a server and several clients;

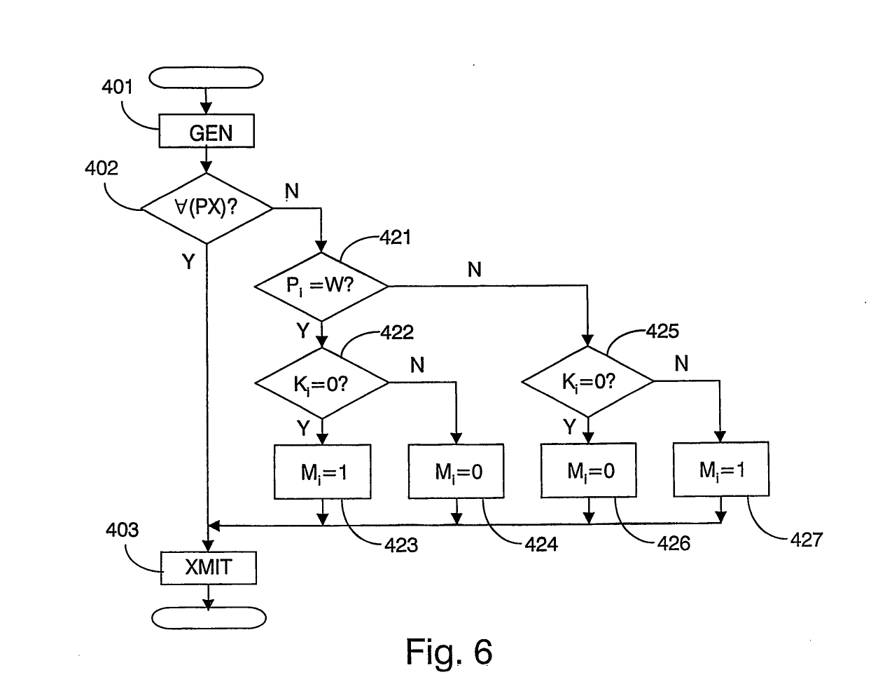

FIG. 6 schematically illustrates the operations by the server to visually encrypt a graphical message before transmission to the client device;

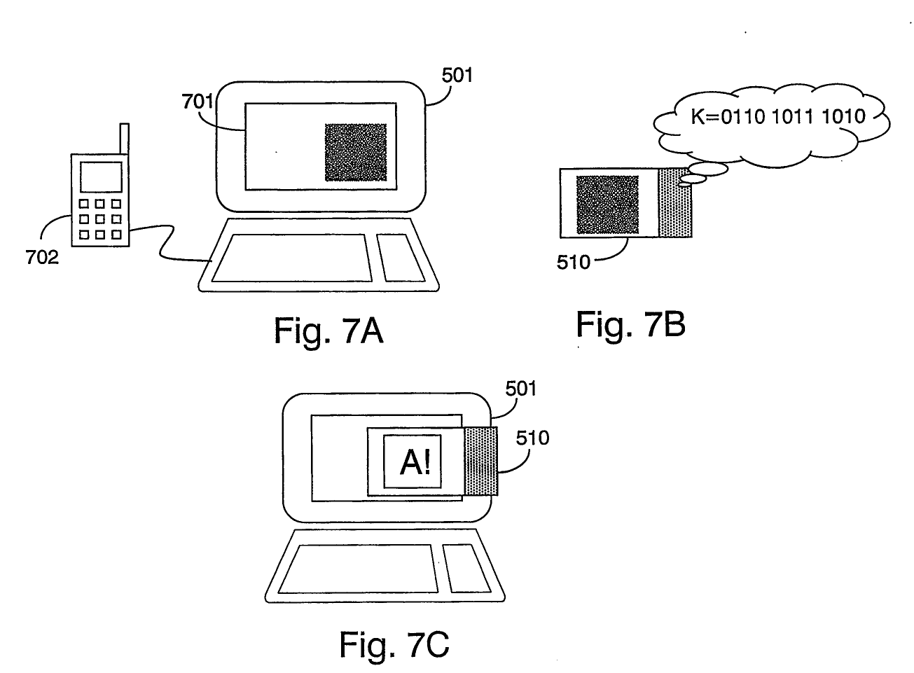

FIGS. 7A-C schematically illustrate the operations of the client device; and

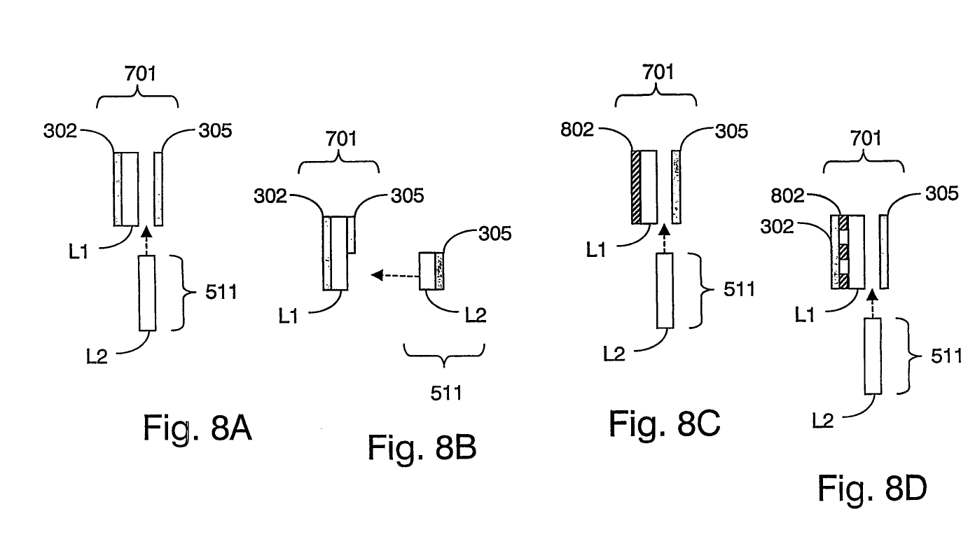

FIGS. 8A-D illustrate various embodiments for the first and second liquid crystal displays used in the client device.

Throughout the figures, same reference numerals indicate similar or corresponding features. Some of the features indicated in the drawings are typically implemented in software, and as such represent software entities, such as software modules or objects.

In order to understand the present invention's use of liquid crystal displays for visual cryptography, first consider the construction of a common transmissive liquid crystal display (LCD) in a backlight setting, as shown in FIG. 3.

A light source 301, typically realized as a backlight positioned behind the LCD screen, projects light waves with all possible polarizations towards a polarization filter 302. Only horizontally polarized light waves pass through this polarization filter 302. The liquid crystal cells 303, 304 normally rotate the polarization of the light waves passing through them by 90 degrees. This is due to the inner molecular structure of the liquid crystal cells 303, 304.

The cells 303, 304 in this embodiment are twisted nematic liquid crystals, which is the most common type. Other types could of course be used instead. Also, rather than using a backlight, a reflective or trnsflective liquid crystal display could be used.

If a sufficient voltage is applied to the liquid crystal cells, the inner molecular structure of the cell changes in such a way that the polarization of passing light is not altered. This is called “activating” the cell. In FIG. 3, such a voltage has been applied to liquid crystal cell 304, but not to liquid crystal cell 303. To indicate that liquid crystal cell 303 rotates the polarization of passing light, it has been marked with the letter “R”.

The light waves that passed through liquid crystal cells 303, 304 subsequently cross a second polarization filter 305. This polarization filter 305 acts like polarization filter 302 in that it only allows horizontally polarized light waves to pass through. Because the polarization of the light that passed through liquid crystal cell 303 had been rotated, this light is blocked by the polarization filter 305, and so the output will appear as a black pixel 306. The polarization of the light that passed through activated liquid crystal cell 304 is still horizontal, and so it passes through polarization filter 305 and appears as a white pixel 307.

Alternatively, the second polarization filter 305 could be chosen to let only light through that has been rotated once by the liquid crystal cell 303. The output of the liquid crystal display will then be exactly opposite to what has been described above. However, this is a mere design variation.

It will be evident that the polarization filters 302 and 305 could also be modified to only allow light waves with other polarizations, e.g. vertical polarizations, to pass through. Furthermore, the liquid crystals 303, 304 might not rotate the polarization of incoming light perpendicular to its original orientation, but for instance rotate it only 45 degrees, as is the case in reflective LCDs, where in addition only a single polarization layer may be present. What is important is that, to produce a black pixel, the final direction of the polarization is perpendicular to the polarization direction of the second polarization filter 305.

For performing visual cryptography, the polarization rotating effect of liquid crystal cells can be used in such a way that no resolution nor light is lost. The necessary modifications are illustrated in FIG. 4. Rather than a single layer of liquid crystals, there are now two layers L1, L2 of crystals between the polarization filters 302 and 305. Voltages can be applied to the cells in each layer L1, L2 separately to active these cells. The polarization of the light passing through the inactive cells 303 will be rotated, while the polarization of light passing through the activated cells 304 will not be rotated. This gives four possible scenarios for light waves that pass from the light source 301 through the polarization filter 302, illustrated in FIG. 4 as A, B, C and D.

A: if a lightwave first passes through an inactive cell 303 in the first layer L1, its polarization is rotated with respect to its original orientation. If subsequently this lightwave passes through an inactive cell 303 in the second layer L2, the polarization is rotated again and so is back at its original orientation. This allows this lightwave to pass through the second polarization filter 305, causing it to show up as a white pixel 307.

B: if a lightwave first passes through an inactive cell 303 in the first layer L1, its polarization is rotated with respect to its original orientation. If subsequently this lightwave passes through an active cell 304 in the second layer L2, the polarization remains unchanged, i.e. rotated with respect to its previous orientation. The second polarization filter 305 will now block this lightwave since it has the “wrong” orientation. As a result, a black pixel 306 shows up.

C: if a lightwave first passes through an active cell 304 in the first layer L1, its polarization remains unchanged. If subsequently this lightwave passes through an inactive cell 303 in the second layer L2, the polarization is rotated with respect to its original orientation. The second polarization filter 305 will now block this lightwave since it has the “wrong” orientation. As a result, a black pixel 306 shows up.

D: if a lightwave first passes through an active cell 304 in the first layer L1, its polarization remains unchanged. If subsequently this lightwave passes through an active cell 304 in the second layer L2, the polarization still remains unchanged. This allows this lightwave to pass through the second polarization filter 305, causing it to show up as a white pixel 307.

FIG. 5 schematically shows a system according to the invention, comprising a server 500 and several clients 501, 502, 503. While the clients 501-503 are embodied here as a laptop computer 501, a palmtop computer 502 and a mobile phone 503, they can in fact be realized as any kind of device, as long as the device is able to interactively communicate with the server 500 and is able to render graphical images on an LCD screen. The communication can take place over a wire, such as is the case with the laptop 501, or wirelessly like with the palmtop computer 502 and the mobile phone 503. A network such as the Internet or a phone network could interconnect the server 500 and any of the clients 501-503.

The server 500 generates an image 520 representing a message that needs to be communicated to the operator of the client 501. The image 520 will be encoded using visual cryptography before transmission, as will become apparent below.

Also shown in FIG. 5 is a personal decryption device 510. This device 510 is personal to a user and should be guarded well, as it is to be used to decrypt visually encoded messages sent by the server 500 to any of the clients 501-503. Anyone who gains physical control over the decryption device 510 can read all visually encrypted messages intended for the user. To add some extra security, entering a password or Personal Identification Number (PIN) could be required before activation of the decryption device 510. The device 510 could also be provided with a fingerprint reader, or be equipped to recognize a voice command uttered by its rightful owner.

The decryption device 510 comprises a display 511 and a storage area 512. The display 511 is preferably realized as an LCD screen with twisted nematic liquid crystals. Although normally such a display 511 would have a polarization filter on both sides of the liquid crystal layers, in this embodiment the display 511 only has one polarization filter (see also FIG. 8B). The LCD screen of the client 501 that receives the visually encrypted message 520 should then have a portion of the topmost polarization filter removed. This portion should be large enough to allow the display 511 to be superimposed upon it. Alternatively, the LCD screen of the client 501 can be provided with a (preferably small) separate display on which the display 511 is to be superimposed. In another embodiment (shown below with reference to FIG. 8A) the display 511 has no polarization filter.

The storage area 512 comprises at least a key sequence to be used in decrypting visually encrypted images. The key sequence is preferably realized as a sequence of bits, e.g. ‘011010111010’. The length of the key sequence stored in the storage area 512 should be long enough to accommodate a large number of decryption operations. When decrypting visually encrypted images, one bit is necessary for every pixel of the original input image. So, if 100×100 pixel images are to be decrypted, 10,000 bits are necessary per image.

Also, after every decryption operation, the key bits used are preferably discarded or marked as used. This way every decryption operation involves the use of a unique subsection of the key sequence. When all key bits have been used, the key sequence in the storage area 512 must be replaced. This can be realized by e.g. asking the owner of the decryption device 510 to replace his decryption device 510 with anew specimen, or to visit a secure location like a bank where it is loaded with a new key sequence.

Alternatively, when a key sequence has been used, a cryptographic hash function or symmetric encryption scheme can be applied to the key sequence. The output of the hash function or encryption scheme is then used as the new key. In this way a series of key sequences can be generated of any length, without having to store all of the key sequences in the personal decryption device 510. Of course, if even one key sequence in the series becomes known to an attacker, the attacker can also reconstruct all future key sequences.

Another, more secure alternative is to employ a stream cipher (e.g. RC4 or SEAL) as a key generator. Stream ciphers encrypt plaintext one bit (or sometimes byte) at a time. The stream of plaintext bits are XORed with the output of a keystream generator which produces a pseudo-random stream of bits based on a seed value (here chosen as bits from the key sequenced stored in the memory 512). This seed value is the key for the stream cipher.

The decryption device 510 also needs to be equipped with hardware and/or software modules (not shown) capable of performing the above cryptographic operations. This could be realized e.g. by adding a processor and a memory comprising the software.

The decryption device 510 is preferably embodied as a unit physically separate, or at least separable, from the client device 501-503. No electrical, optical or other communication paths between the decryption device 510 and the client should exist. As the patterns and the key sequence are provided in digital (electronic) form, any such communication paths could potentially be abused by an attacker to obtain a portion of the key sequence. Without such paths, a compromised client device cannot obtain information from the decryption device 510 in any way. This way, it is achieved that the user does not have to trust the security of the client 501.

FIG. 6 schematically illustrates the operations by the server 500 to visually encrypt the image 520 before transmission to the client 501. At step 401, the server 500 generates the image 520 representing a message to be transmitted to the client 501. This image 520 can simply be a graphical representation of a textual message, but might also comprise images.

In step 402, the server 500 generates a bit sequence to be transmitted to the client device 501 by examining every pixel in the image 520 and choosing an appropriate bit. First, the pixel is examined in step 421 to determine its color. Typically images generated in step 401 will be in black and white, although of course other colors, can also be used. However, in this embodiment it is assumed that the images comprise only black and white pixels. If the color of the pixel is found to be white, the method proceeds to step 422. Otherwise, the method proceeds to step 425.

As noted above, the decryption device 510 holds a key sequence in storage area 512. The server 500 holds a copy of this key sequence. Usually the server 500 knows in advance which user is operating the client device 501, and then can simply look up the appropriate key sequence. The server 500 may also want to use a particular key sequence without knowing in advance which user is operating the client device 501. This ensures that only the person owning the personal decryption device with that particular key sequence can read the information contained in the message to be transmitted to the client device 501.

Every bit in the key sequence is to be used only once. To this end, usually a pointer indicating the current position in the key sequence is maintained. This current position is referred to as the i^{th} position. After using a bit from the key sequence, the pointer is increased by 1. If all the bits from the key sequence have been used, the key sequence must be replaced, or the above-mentioned hash function or symmetric encryption function should be applied to it to obtain a new key sequence. It is observed that the security of the system for a large part depends on the quality of the pseudo-random number generator used for generating key sequences.

In step 422, the i^{th} bit of the keysequence. (Kᵢ) is examined to determine whether it is ‘0’ or ‘1’. If it is ‘0’, then at step 423 the corresponding i^{th} bit of the sequence is chosen to be ‘1’. If it is ‘1’, then at step 424 the i^{th} bit is chosen to be ‘0’.

Similarly, if the pixel is black, then at step 425 the i^{th} bit of the key sequence is also examined to determine whether it is ‘0’ or ‘1’. If it is ‘0’, then at step 426 the i^{th} bit is chosen to be ‘0’. If it is ‘1’, then at step 427 the i^{th} bit is chosen to be ‘1’.

It is observed that the above steps can be implemented very efficiently by representing white pixels as ‘1’ and black pixels as ‘0’. The i^{th} bit of the message (Mᵢ) can then easily be computed using the XOR operator: Mᵢ=Pᵢ xor Kᵢ, where Mᵢ is the i^{th} bit in the bit sequence to be transmitted, Pᵢ is the i^{th} pixel in the image 520, and Kᵢ is the i^{th} bit in the key sequence.

When all pixels have been processed, the bit sequence is transmitted in step 403 to the client device 501. Such transmissions are straightforward to implement and will not be elaborated upon here. Note that it is not necessary to protect this transmission by e.g. encrypting the bit sequence before transmitting it. Because of the process used to choose these bits, it is impossible for an eavesdropper to recover the image 520 by using only the bit sequence.

FIGS. 7A-C schematically illustrate the operation of the client device 501. The client device 501 is in this embodiment connected to a network such as the Internet using a mobile phone 702, as is generally known in the art. Using a data connection established using the mobile phone 702, the client device 501 can transmit data to and receive data from the server 500.

In FIG. 7A, the device 501 receives a sequence of information units, here a number of binary values (bits), from the server 500 and displays the bits as pixels on a portion of liquid crystal display 701. This portion can be an area of a relatively large multi-purpose display, or the entirety of a relatively small dedicated display. Typically a bit with value ‘0’ is displayed as a black pixel, and a bit with value ‘1’ is displayed as a white pixel, although of course any combination of colors can be used. To display the bits as pixels, liquid crystals in the display 701 are activated if the value is ‘1’, and not activated if the value is ‘0’.

Observe that no processing or decrypting step is necessary in the device 501 before any displaying takes place; the bit sequence is displayed as it is received. It may be advantageous to display the pixels in a corner of the display 701, as will become apparent below. If the display 701 does not comprise a topmost polarization filter, the displayed black and white pixels will not become directly visible to a user.

Upon recognizing that a visually encrypted image has been sent to the client device 501, the user in FIG. 7B takes his personal decryption device 510 and activates it. This causes the decryption device 510 to output a graphical representation in dependence on the key sequence stored in storage area 512.

The decryption device 510 must be programmed in advance with the dimensions of the image that was generated by the server 500. Of course, an input means that allows the user to enter these dimensions for each image separately can also be provided, but this makes the decryption device 510 more complex and more expensive.

For each pixel in each row of the image generated by the server 500, the decryption device 510 activates a liquid crystal if the corresponding bit of the key sequence represents a ‘0’, and deactivates that crystal if the corresponding bit of the key sequence represents a ‘1’. Note that this is the opposite of the operations in the client 501, where liquid crystals on the display 701 were instead activated if the corresponding bits were ‘1’ and not activated if the corresponding bits were ‘0’.

In FIG. 7C, the user superimposes the personal decryption device 510 upon the pixels displayed on display 701. To facilitate such superimposing, the edge of the display 701 can be provided with hooks or clamps in a corner (not shown), by which the personal decryption device 510 can be fastened to a particular position on top of the display 701. This way, it is very easy for the user to properly superimpose the personal decryption device 501 upon the patterns on the display 701 if these patterns are displayed in the corresponding position on the display 701. This positioning must be done exactly correct for the invention to work. If the two displayed images are even aligned incorrectly by one pixel, no reconstruction takes place.

Because both the decryption device 510 and the client device 501 each effectively display one share of a visually encrypted image, the user can now observe the reconstructed image. Because neither the client 501 nor the personal decryption device 510 at any time has sufficient information to reconstruct the image itself, the contents of the image 520 cannot be recovered by a malicious application running on either device. Further, since the personal decryption device 510 does not have any communication means, it is impossible to obtain the key sequence from the storage area 512 without gaining physical access to the decryption device 510.

The invention can be used to transmit a wide variety of messages from server 500 to client 501. For example, sensitive information like a bank balance, a private e-mail message, a new PIN code or password can be provided to the operator of client 501.

One particularly useful application is to securely allow composition of a message by the operator of client 501. In this embodiment, the server generates the image 520 so that it represents a plurality of input means such as keys on a keyboard. Each input means represents an input word that can be used in the message that will be composed by the user. Next to keys, the input means could also be checkboxes, selection lists, sliders or other elements typically used in user interfaces to facilitate user input.

The server 500 then applies the steps as mentioned above with reference to FIG. 6 to obtain a bit sequence, which is then sent to the client device 501. The user positions his decryption device 510 above the area in which the bit sequence is displayed, activates the decryption device 510 and then is able to view the input means.

The user then composes the message by selecting keys or other input means rendered as an image on the display of the client device 501. Such keys could be visually rendered as keys representing different alphanumerical characters, or as buttons representing choices like ‘Yes’, ‘No’, ‘More information’ and so on. Other ways to visually represent input means are well known in the art.

Selecting the input means is preferably done by selecting a particular set of coordinates on the display of the client device 501. Preferably, the user inputs the set of coordinates by applying pressure to a particular spot of the display, the set of coordinates corresponding to the particular spot. Because the image representing the input means can only be seen when the decryption device 510 is superimposed upon the client 501, the user is advised to apply pressure to the display 511 of the decryption device 510. This pressure will be transferred to the display of the client 501, which when equipped with a touch-sensitive screen can register the spot to which pressure was applied, and translate this to a set of coordinates.

Of course, other input devices such as a mouse, a graphics tablet or even a keyboard can also be used. If a graphical cursor is to be used in conjunction with such input devices (e.g. selection of an input means by positioning a cursor over it and pressing a mouse or keyboard button), then positioning the display 511 below the display 701 is advantageous, as the cursor will be well visible in this case.

By itself it is known to allow composition of a message through visually rendered input means on a display, see e.g. U.S. Pat. No. 6,209,102. This U.S. patent, however, does not protect the composed message against interception by an eavesdropper. It also fails to teach how such an image representing input means can securely be transmitted to the client device 501. This means that an eavesdropper can learn the layout of the input means represented on the image, and learn from the feedback sent by the client device 501 to the server 500 which input means were selected.

It is observed that different input means may, but need not necessarily, represent different input words. Providing multiple input means representing the same input word has the advantage that a sequence of inputs made by the user appears to be random even when the sequence contains repetitions. As used here, the term “word” can mean single alphanumerical characters, but also texts like ‘Yes’, ‘No’ and so on, as well as other linguistic or symbolic elements.

Having received one or more sets of coordinates, the client device 501 transmits these sets of coordinates to the server 500. It is observed that eavesdropping software secretly installed on the client device 501 cannot learn any passwords or sensitive information entered in this fashion. At the most, such software would be able to learn the particular sets of coordinates entered in this particular session. These sets could then be used to impersonate the user in a future session.

To prevent this type of so-called ‘replay’ attack, the server 500 should randomize the placement of the input means on the image generated in step 401. If the eavesdropping software then retransmits the sets of coordinates it learned, in order to impersonate the user in a subsequent session, the server 500 will not authenticate the impersonator, as the sets of coordinates do not correspond to the correct password or other authentication code. In fact, these sets of coordinates need not even correspond to the location of input means on the image generated in the subsequent session.

When the server 500 receives the sets of coordinates, it translates each set of coordinates to a particular input means represented on the image. Since the server 500 composed this image, translating a set of coordinates to an input means in the server 500 is straightforward. Finally, the message composed by the user is constructed as the input words represented by the particular input means to which the sets of coordinates were translated. See e.g. the above-mentioned U.S. Pat. No. 6,209,102 for more information.

While the message composed in the above fashion can of course contain any kind of information, preferably this message contains an authentication code such as a PIN code or a password. The server 500 can now check the PIN code or password to verify the credentials of the user, and grant access, perform one or more privileged operations or perform some other action for which these credentials are necessary. The server 500 could also signal another system upon a successful verification of the credentials.

FIGS. 8A-8D illustrate various embodiments for the liquid crystal displays 701 and 511. Ordinary liquid crystal displays are constructed as shown in FIG. 3, with two polarization layers and a layer with liquid crystals in between. However, as can be seen in FIG. 4, in the invention the two liquid crystal layers L1 and L2 are superimposed on each other, without intervening polarization layers.

In FIG. 8A, the liquid crystal display 701 comprises first polarization layer 302, liquid crystal layer L1 and second polarization layer 305. A space has been left open between liquid crystal layer L1 and second polarization layer 305, which is large enough to accommodate the insertion of the liquid crystal display 511. This may require an opening in the client 501 in which the liquid crystal display 701 is installed, so that the user can easily perform the insertion. Having done so, the arrangement of liquid crystal layers and polarization layers of FIG. 4 appears.

The opening or slot can be either between the first polarization layer 302 and the liquid crystal layer L1 , or between the liquid crystal layer L1 and the second polarization layer 305 (the latter is shown in FIG. 8A). Note that the user would view the output from the right side of FIG. 8A (as the light source would be on the left, see also FIGS. 3 and 4). In a preferred embodiment the slot will be situated on the non-viewing side as this allows easy use of a touch screen in the client device 501.

In FIG. 8B, the construction of the liquid crystal display 701 is conventional, but a portion of the second polarization layer 305 has been omitted in the liquid crystal display 701. This portion is chosen to be large enough to accommodate superposition of the liquid crystal display 511 on the underlying liquid crystal layer L1.

In the construction of the liquid crystal display 511 a portion of one of the polarization layers has been omitted as well. Preferably this portion is of equal dimensions as the portion omitted in the liquid crystal display 701. This way, when superimposing the liquid crystal display 511 on the liquid crystal display 701, the liquid crystal layers L1 and L2 are directly put on top of each other, without intervening polarization layers. As with FIG. 8A, this superimposing results in the arrangement of FIG. 4.

In FIG. 8C the liquid crystal display 701 comprises a scattering mirror 802, rather than the first polarization filter 302. The second liquid crystal display 511 can now be inserted either between the first liquid crystal layer L1 and the polarization filter 305 or between the first liquid crystal layer L1 and the scattering mirror 802. In this embodiment no light source 301 is necessary, as incoming ambient light now serves as light source. This makes the display 701 in this embodiment a reflective liquid crystal display.

In this embodiment, the liquid crystal cells 303, 304 should rotate the incoming light at an angle of 45 degrees with respect to its original orientation, rather than 90 degrees as would be the case with a transmissive display. The light passes twice through the cells because of the mirror 802, and so will be rotated 45 degrees twice by the cells to produce a final polarization of 0, 90 or 180 degrees.

In FIG. 8D a transflective display 701 is used, comprising both the mirror 802 and the polarization filter 302. The mirror 802 is now realized as a mesh or grid, so that light coming from the backlight 301 (not shown) can pass through the mirror 802. Incoming ambient light can still be reflected by the mirror 802. This way, the user can activate the backlight if the incoming ambient light is insufficient to produce a clear image, or deactivate the backlight to save power. This is especially useful when the display 701 is comprised in a standalone device with a battery, like a mobile telephone.

It should be noted that the above-mentioned embodiments illustrate rather than limit the invention, and that those skilled in the art will be able to design many alternative embodiments without departing from the scope of the appended claims. For instance, a color filter can be used to change the color of the output pixels from black and white, if desired. The decryption device 510 can be incorporated in the lid of the client device 501, which makes properly positioning the display 511 over the display 701 trivial. Of course there should be no connection between the lid and the client device 501, other than any mechanical connections necessary to open and/or close the lid.

The invention can be used in any kind of device in which a secure communication from a server to a client and/or vice versa is necessary. Client devices can be embodied as personal computers, laptops, mobile phones, palmtop computers, automated teller machines, public Internet access terminals, or in fact any client device that is not completely trusted by its user to not contain any malicious software or hardware.

In the claims, any reference signs placed between parentheses shall not be construed as limiting the claim. The word “comprising” does not exclude the presence of elements or steps other than those listed in a claim. The word “a” or “an ” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of reconstructing a graphical message (520), comprising receiving a sequence of information units, activating cells (303, 304) in a first liquid crystal layer (L1) of a first liquid crystal display (701) in dependence on the sequence, activating cells (303, 304) in a second liquid crystal layer (L2) of a second liquid crystal display (511), different from the first liquid crystal display (701), in dependence on elements in a key sequence, and superimposing the first and second displays (701, 511) so as to reconstruct the graphical message (520).

2. The method of claim 1, in which polarized light is incident on the liquid crystal layers (L1, L2).

3. The method of claim 1, comprising for each information unit in the sequence, activating a corresponding cell (304) in the first liquid crystal layer (L1) if the information unit represents a first value, and not activating the corresponding cell (303) if the information unit represents a second value.

4. The method of claim 1, comprising for each element in the key sequence, activating a corresponding cell (304) in the second liquid crystal layer (L2) if the element represents a second value, and not activating the corresponding cell (303) if the element represents a first value.

5. A device (501) arranged for reconstructing a graphical message (520), comprising receiving means (702) for receiving a sequence of information units, a first liquid crystal display (701) arranged for displaying the sequence of information units by activating cells (303, 304) in a first liquid crystal layer (L1) in dependence on the sequence, a second liquid crystal display (511), different from the first liquid crystal display (701), arranged for activating cells (303, 304) in a second liquid crystal layer (L2) in dependence on elements in a key sequence, in which the first and second liquid crystal display (511) are arranged to be superimposed on each other.

6. The device (501) of claim 5, in which the second liquid crystal display (511) is embodied in a unit (510) physically separable from the first liquid crystal display (701), and provided with a memory (512) for storing the key sequence.

7. The device (501) of claim 5, comprising means for receiving input representing a set of coordinates from a user, and means (702) for transmitting the received input to a server (500).

8. The device (501) of claim 7, in which the input is received as pressure on a particular spot of the first liquid crystal display (701), the set of coordinates corresponding to the particular spot.

9. The device (501) of claim 5, further comprising at least one polarizing means (305) for polarizing light incident upon the first and second liquid crystal layers (L1, L2).

10. The device (501) of claim 5, in which a portion of a polarization filter (305) in an area of the first liquid crystal display (701), and a corresponding portion of a polarization filter (302) in an area of the second liquid crystal display (511) have been omitted to allow superimposition of the first and second liquid crystal displays (701, 511) at said areas.

11. The device (501) of claim 5, in which the second liquid crystal layer (L2) is operable to be inserted between a polarization filter (305) of the first liquid crystal display (701) and the first liquid crystal layer (L1) in the first liquid crystal display (701).
